(19) United States
(12) Patent Application Publication
(10) Pub. No.: US 2022/0139590 A1
(43) Pub. Date: May 5, 2022

(54) COPPER FINE PARTICLES, CONDUCTIVE MATERIAL, APPARATUS FOR PRODUCING COPPER FINE PARTICLES, AND METHOD FOR PRODUCING COPPER FINE PARTICLES

(71) Applicant: TAIYO NIPPON SANSO CORPORATION, Tokyo (JP)

(72) Inventors: Yuji SAKURAMOTO, Tokyo (JP); Ryuhei HOSOKAWA, Tokyo (JP); Hiroshi IGARASHI, Tokyo (JP)

(21) Appl. No.: 17/299,075

(22) PCT Filed: Dec. 19, 2019
(86) PCT No.: PCT/JP2019/049884

§ 371 Date: Jun. 2, 2021

(30) Foreign Application Priority Data
Jan. 22, 2019 (JP) 2019-008521

(51) Int. Cl. H01B 1/22; B22F 1/16; B22F 1/0545; B22F 9/22

(52) U.S. Cl. CPC H01B 1/22; B22F 1/16; B22F 1/0545; B22F 9/22; B22F 2304/058; B22F 2302/45; B22F 2304/054; B22F 2302/25; B22F 2304/056; B22F 2301/10

(57) ABSTRACT

One object of the present invention is to provide copper fine particles which have sufficient dispersibility when made into a paste and can be sintered at 150° C. or lower, the present invention provides copper fine particles, wherein the copper fine particles have a coating film containing copper carbonate and cuprous oxide on at least a part of the surface thereof, and a ratio between the following Db and the following Dv (Db/Dv) is in a range of 0.50˜0.90, Dv: an average value (nm) of the area equivalent circle diameter of the copper fine particles obtained by acquiring SEM images for 500 or more copper fine particles using a scanning electron microscope, and calculating by image analysis software, Db: a particle size (nm) of the copper fine particles obtained by measuring a specific surface area (SSA (m²/g)) of the copper fine particles using a specific surface area meter, and calculating by the following formula (1), Db=6/(SSA×ρ)×10⁹ . . . (1) in the formula (1), ρ is a density of copper (g/m³).

### TECHNICAL FIELD

The present invention relates to copper fine particles, a conductive material, an apparatus for producing copper fine particles, and a method for producing copper fine particles.

### BACKGROUND ART

Technological progress in the field of high-density wiring has been remarkable in terms of high-performance, miniaturization, and weight reduction of printed wiring boards used for electronic components. Conductive inks, conductive pastes, and the like are known as conductive materials for forming high-density wiring.

As a conductive material, a material containing silver fine particles is conventionally known. However, silver has problems such as high cost and migration. Therefore, alternatives to conductive materials containing copper fine particles, which are inexpensive and have conductivity equivalent to that of silver, have been considered.

In general, since copper fine particles have a relatively high sintering temperature, a conductive material containing copper fine particles is used in a resin material having high heat resistance such as polyimide. However, since a resin material having high heat resistance such as polyimide is expensive, it is a factor that increases the cost of electronic parts.

Therefore, conductive materials containing copper fine particles are required to be inexpensive and applicable to resin materials having relatively low heat resistance, such as polyethylene terephthalate.

As a method for producing copper fine particles applicable to a conductive material, the production methods disclosed in Patent Documents 1 and 2 have been proposed.

Patent Documents 1 and 2 disclose a method of forming a reducing flame with a burner in a furnace and blowing a metal into the reducing flame to obtain copper fine particles.

### PRIOR ART DOCUMENTS

### Patent Documents

Patent Document 1 Japanese Patent No. 4304212
Patent Document 2 Japanese Patent No. 4304221

### SUMMARY OF INVENTION

### Problem to be Solved by the Invention

However, since the copper fine particles obtained by the production methods disclosed in Patent Documents 1 and 2 have a sinterable temperature range of 170° C. or higher, the copper fine particles can be hardly used in resin materials having low heat resistance such as polyethylene terephthalate.

In the production methods disclosed in Patent Documents 1 and 2, the particle size of copper fine particles can be made relatively small (for example, about 40 nm) for the purpose of lowering the sinterable temperature range. However, when the particle size of the copper fine particles is reduced, the cohesiveness of the copper fine particles increases as the specific surface area increases. Therefore, if the particle size of the copper fine particles is reduced in order to lower the sintering temperature, the dispersibility of the copper fine particles as a paste may decrease.

An object of the present invention is to provide copper fine particles which have sufficient dispersibility when made into a paste and can be sintered at 150° C. or lower.

### Means for Solving the Problem

In order to achieve the object, the present invention provides the following copper fine particles, conductive material, apparatus for producing copper fine particles, and method for producing copper fine particles.

[1] Copper fine particles,

wherein the copper fine particles have a coating film containing copper carbonate and cuprous oxide on at least a part of the surface thereof, and

a ratio between the following Db and the following Dv (Db/Dv) is in a range of 0.50˜0.90,

Dv: an average value (nm) of the area equivalent circle diameter of the copper fine particles obtained by acquiring SEM images for 500 or more copper fine particles using a scanning electron microscope, and calculating by image analysis software,

Db: a particle size (nm) of the copper fine particles obtained by measuring a specific surface area (SSA (m²/g)) of the copper fine particles using a specific surface area meter, and calculating by the following formula (1),

Db=6/(SSA×ρ)×10⁹ (1)

in the formula (1), ρ is a density of copper (g/m³).

[2] The copper fine particles according to [1],

wherein the Dv is in a range of 50˜500 nm.

[3] The copper fine particles according to [1] or [2],

wherein the Db is in a range of 25˜500 nm.

[4] A conductive material,

wherein the conductive material contains the copper fine particles according to any one of [1] to [3], and a dispersion medium in which the copper fine particles are dispersed.

[5] An apparatus for producing the copper fine particles according to any one of [1] to [3],

wherein the apparatus includes:

a first processing unit which includes a burner forming a reducing flame, and a furnace configured to store the burner, and which is configured to heat copper or a copper compound in the reducing flame, and produce fine particles having a coating film containing copper carbonate and cuprous oxide on at least a part of the surface thereof, and

a second processing unit which is configured to bring the fine particles into contact with pure water to dissolve the copper carbonate in the coating film.

[6] A method for producing the copper fine particles according to any one of [1] to [3], wherein the method includes:

heating copper or a copper compound in a reducing flame formed in a furnace by a burner to produce fine particles having a coating film containing copper carbonate and cuprous oxide on at least a part of the surface thereof; and

bringing the fine particles into contact with pure water to dissolve the copper carbonate in the coating film.

[7] The method for producing the copper fine particles according to [6],

wherein an amount of carbon in the fine particles is controlled by adjusting an amount of carbon in a fuel gas supplied into the burner.

[8] The method for producing the copper fine particles according to [6] or [7],

wherein the fine particles are heat-treated in a carbon dioxide atmosphere before the fine particles are brought into contact with pure water.

### Effects of the Invention

According to the present invention, it is possible to provide copper fine particles which have sufficient dispersibility when made into a paste and can be sintered at 150° C. or lower.

### BRIEF DESCRIPTION OF DRAWINGS

FIG. 1 is a schematic diagram showing a configuration of an apparatus for producing copper fine particles according to an embodiment of the present invention.

FIG. 2 is a planar diagram of the tip end of a burner shown in FIG. 1.

FIG. 3 is a diagram showing a cross section of the tip end of a burner shown in FIG. 2 taken along line B-B.

FIG. 4 is a diagram showing a cross section of a furnace and an inert gas supply unit shown in FIG. 1 taken along line A-A.

FIG. 5 is a diagram showing an SEM photograph (magnification: 50,000 times) of copper fine particles of Example 1.

FIG. 6 is a diagram showing an SEM photograph (magnification: 50,000 times) of copper fine particles of Comparative Example 1.

FIG. 7 is a diagram showing the relationship between the carbon concentration of fine particles and Db/Dv of copper fine particles.

### DETAILED DESCRIPTION OF THE PREFERRED EMBODIMENTS

In the present description, the meanings of the following terms are as follows.

Copper fine particles are copper particles with an average particle size of less than 1 μm.

“˜” indicating a numerical range means that the numerical values before and after are included as the lower limit value and the upper limit value.

<Copper Fine Particles>

The copper fine particles of the present invention have a coating film containing copper carbonate and cuprous oxide on at least a part of the surface thereof. In the copper fine particles of the present invention, the coating film containing copper carbonate and cuprous oxide may further contain copper oxide.

At least a part of the surface of the copper fine particles of the present invention is coated with a coating film containing copper carbonate and cuprous oxide. Then, irregularities are formed on the surface of the copper fine particles of the present invention. In the present invention, a ratio (Db/Dv) between the following Db and the following Dv is used as an index of the degree of irregularities formed on the surface of the copper fine particles.

Dv: An average value (nm) of an area equivalent circle diameter of the copper fine particles obtained by acquiring SEM images for 500 or more copper fine particles using a scanning electron microscope, and calculating by image analysis software.

Db: A particle size (nm) of the copper fine particles obtained by measuring a specific surface area (SSA (m²/g)) of the copper fine particles using a specific surface area meter, and calculating by the following formula (1)

Db=6/(SSA×ρ)×10⁹ (1)

in the formula (1), p is the density of copper (g/m³).

The ratio (Db/Dv) of the copper fine particles of the present invention is 0.50˜0.90, preferably 0.50˜0.80, and more preferably 0.50˜0.70. When the ratio (Db/Dv) of the copper fine particles is the lower limit value or more, the dispersibility of the copper fine particles when made into a paste is sufficient. When the ratio (Db/Dv) of the copper fine particles is the upper limit value or less, the sintering temperature of the copper fine particles is lowered, and sintering is possible at 150° C. or less.

Dv may be, for example, 50˜500 nm, or 70˜200 nm.

Db may be, for example, 25˜500 nm, or 35˜200 nm.

When Dv or Db is the lower limit value or more, the aggregation of the copper fine particles is suppressed, and the dispersibility when made into a paste is improved. When Dv or Db is the upper limit value or less, the sintering temperature is further lowered, and sintering is easily performed at 150° C. or less.

The thickness of the coating film on the surface of the copper fine particles is not particularly limited. For example, the thickness of the coating film of the copper fine particles of the present invention may be about several nm.

The amount of cuprous oxide in the coating film of the copper fine particles of the present invention is preferably 80% by mass or more and less than 100% by mass.

The amount of copper carbonate in the coating film of the copper fine particles of the present invention is preferably more than 0% by mass and 20% by mass or less.

When the amount of cuprous oxide in the coating is 80% by mass or more and less than 100% by mass, and the amount of copper carbonate in the coating is more than 0% by mass and 20% by mass or less, the effect that the sintering temperature is lower than 150° C. can be obtained more remarkably.

Further, the amount of copper carbonate in the coating film on the surface of the copper fine particles is preferably a low amount within the range above, for example, more preferably more than 0% by mass and 10% by mass or less, and most preferably more than 0% by mass and 5% by mass or less.

The amounts of cuprous oxide and copper carbonate in the coating film of the copper fine particles are measured by XPS analysis using an analyzer (“PHI Quantum 2000” manufactured by ULVAC-PHI).

(Effects)

Since the copper fine particles of the present invention described above have irregularities formed on the surface thereof, the specific surface area of the copper fine particles increases and the reaction activity of the copper fine particles increases. As a result, sintering is possible even in a temperature range of 150° C. or lower.

More specifically, since the ratio (Db/Dv), which is an index of the degree of irregularities formed on the surface of the copper fine particles, is 0.50˜0.90, as shown in Examples described later, a paste produced using the copper fine particles has sufficient dispersibility and can be sintered at 150° C. or lower.

(Use)

The copper fine particles of the present invention can be used in, for example, the preparation of conductive materials.

The conductive material may include, for example, the copper fine particles of the present invention and a dispersion medium.

Examples of the dispersion medium include alcohols such as ethanol and propanol; polyols such as ethylene glycol and polyethylene glycol; and monoterpene alcohols such as α-terpineol and β-terpineol. The conductive material may be in the form of a conductive paste or a conductive ink.

Since the conductive material contains the copper fine particles of the present invention, the conductive material has sufficient dispersibility of the copper fine particles and can be sintered at 150° C. or lower.

<Apparatus for Producing Copper Fine Particles>

The apparatus for producing copper fine particles of the present invention is an apparatus for producing the copper fine particles of the present invention described above.

Hereinafter, an embodiment of an apparatus for producing copper fine particles of the present invention will be described in detail with reference to drawings.

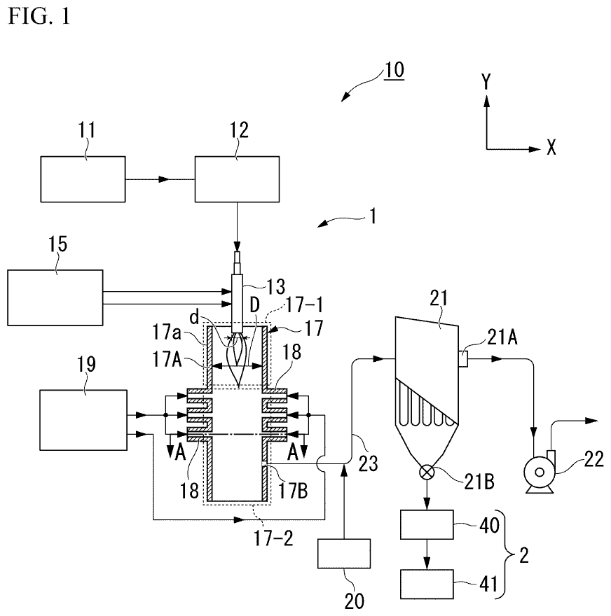

FIG. 1 is a schematic diagram showing a configuration of an apparatus 10 for producing the copper fine particles of the present embodiment.

As shown in FIG. 1, the apparatus 10 includes a first processing unit 1 and a second processing unit 2. The first processing unit 1 includes a fuel gas supply source 11, a raw material feeder 12, a burner 13, a combustion-supporting gas supply source 15, a furnace 17, a plurality of inert gas supply units 18, an inert gas supply source 19, a cooling gas supply source 20, a bag filter 21, and a blower 22. The second processing unit 2 includes a mixer 40 and a solid-liquid separator 41.

(First Processing Unit)

The first processing unit 1 produces fine particles having a coating film containing copper carbonate and cuprous oxide on at least a part of the surface thereof. The fuel gas supply source 11 is connected to the raw material feeder 12. The fuel gas supplied from the fuel gas supply source 11 is supplied into the burner 13 together with the raw material powder supplied from the raw material feeder 12. The fuel gas also functions as a carrier gas for carrying the raw material powder. Examples of the fuel gas include methane, propane, and butane.

The raw material feeder 12 is connected to the fuel gas supply source 11 and the burner 13. The raw material feeder 12 supplies the raw material powder into the burner 13.

As the raw material powder, copper particles or particles of a copper compound (copper oxide, copper nitrate, copper hydroxide, and the like) may be used. The copper compound is not particularly limited as long as it is a compound in which copper oxide is produced by heating and contains copper with a purity of 20% or more.

The particle size of the raw material powder is not particularly limited. Usually, the particle size of the raw material powder is 1˜50 nm.

The burner 13 forms a flame by burning the fuel gas using oxygen or oxygen-enriched air as the combustion-supporting gas. At this time, a reducing flame (hereinafter, “reducing flame”) in which hydrogen and carbon monoxide remain can be formed by supplying an amount of oxygen (combustion-supporting gas) smaller than the amount of oxygen which completely burns the fuel gas.

The burner 13 is arranged at the top (upper end) of the furnace 17 so that the extending direction of the burner 13 coincides with the Y direction (see FIG. 1) which is the vertical direction of the furnace 13. The tip end of the burner 13 forming the reducing flame is housed in the upper end of the furnace 17. As a result, the burner 13 forms the reducing flame in the upper portion of the furnace 17.

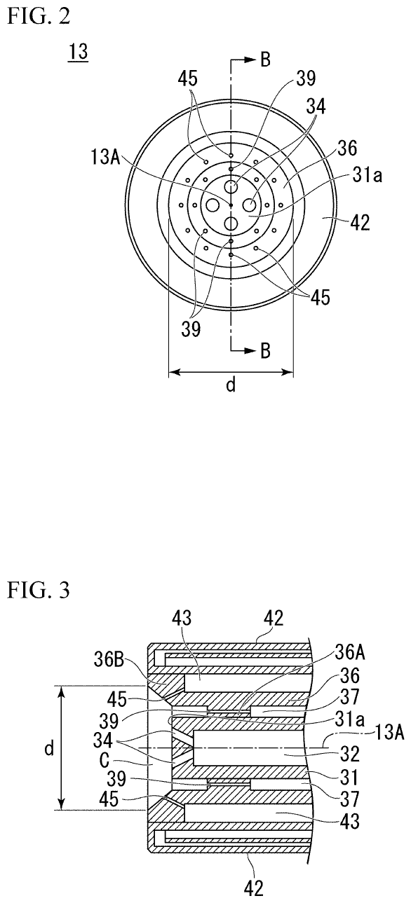

FIG. 2 is a planar diagram of the tip end of the burner 13 shown in FIG. 1, and FIG. 3 is a diagram showing a cross section of the tip end of the burner 13 shown in FIG. 2 taken along line B-B.

As shown in FIGS. 2 and 3, the burner 13 includes a raw material supply pipe 31, a raw material supply path 32, a plurality of raw material ejection holes 34, a primary combustion-supporting gas supply pipe 36, and a primary combustion-supporting gas supply path 37, a plurality of primary combustion-supporting gas ejection holes 39, a cooling jacket pipe 42, a secondary combustion-supporting gas supply path 43, and a plurality of secondary combustion-supporting gas ejection holes 45.

The raw material supply pipe 31 extends in the axial direction of the burner 13 and is arranged at the center of the burner 13. The central axis of the raw material supply pipe 31 coincides with the central axis 13A of the burner 13.

The raw material supply path 32 is a space inside the raw material supply pipe 31, and extends in the axial direction of the burner 13. The raw material supply path 32 is connected to the raw material feeder 12.

The raw material supply path 32 transports the raw material powder and the carrier gas (including the fuel gas) to the tip end side of the burner 13. The carrier gas may be a single fuel gas, or may be a mixed gas of the fuel gas and an inert gas (for example, nitrogen, argon, and the like) supplied from a supply device (not shown).

The plurality of raw material ejection holes 34 are provided so as to penetrate the end portion (the end portion on the side at which the reducing flame is formed) of the raw material supply pipe 31. The plurality of raw material ejection holes 34 are arranged radially on the same circumference with respect to the central axis 13A of the burner 13 at equal intervals. The plurality of raw material ejection holes 34 can be provided so as to be inclined outward by, for example, 15 to 50° with respect to the central axis 13A of the burner 13.

The primary combustion-supporting gas supply pipe 36 extends in the axial direction of the burner 13, and houses the raw material supply pipe 31 inside thereof. The central axis of the primary combustion-supporting gas supply pipe 36 coincides with the central axis 13A of the burner 13. The primary combustion-supporting gas supply pipe 36 has a ring-shaped protrusion portion 36A inside thereof. The protruding portion 36A is in contact with the outer surface of the raw material supply pipe 31.

The primary combustion-supporting gas supply pipe 36 has a front plate portion 36B arranged on the tip end side of the burner 13. The front plate portion 36B is arranged so as to protrude from the tip end surface 31a of the raw material supply pipe 31. Further, the inner wall of the front plate portion 36B is an inclined surface of which the opening diameter becomes smaller toward the tip end surface 31a of the raw material supply pipe 31 from the tip end of the front plate portion 36B.

As a result, a combustion chamber C, which is a mortar-shaped space, is formed on the tip end surface 31a side of the raw material supply pipe 31.

The primary combustion-supporting gas supply path 37 is an annular space formed between the raw material supply pipe 31 and the primary combustion-supporting gas supply pipe 36. The primary combustion-supporting gas supply path 37 is connected to the combustion-supporting gas supply source 15. The primary combustion-supporting gas supply path 37 transports the primary combustion-supporting gas (for example, oxygen or oxygen-enriched air) supplied from the combustion-supporting gas source 15.

The plurality of primary combustion-supporting gas ejection holes 39 are provided so as to penetrate the protrusion portion 36A, and are arranged at equal intervals on the circumference. The center of the circle passing through the plurality of primary combustion-supporting gas ejection holes 39 coincides with the central axis 13A of the burner 13.

The plurality of primary combustion-supporting gas ejection holes 39 eject the primary combustion-supporting gas transported by the primary combustion-supporting gas supply path 37 in parallel with respect to the central axis 13A of the burner 13.

The cooling jacket pipe 42 has a cylindrical shape and is provided on the outside of the primary combustion-supporting gas supply pipe 36 so as to accommodate the primary combustion-supporting gas supply pipe 36. The central axis of the cooling jacket pipe 42 coincides with the central axis 13A of the burner 13.

The cooling jacket pipe 42 has a double pipe structure through which cooling water can flow. As a result, the cooling jacket pipe 42 cools the burner 13 with the cooling water.

The secondary combustion-supporting gas supply path 43 is an annular space formed between the primary combustion-supporting gas supply pipe 36 and the cooling jacket pipe 42. The secondary combustion-supporting gas supply path 43 is connected to the combustion-supporting gas supply source 15. The secondary combustion-supporting gas supply path 43 transports the secondary combustion-supporting gas (for example, oxygen or oxygen-enriched air) supplied from the combustion-supporting gas supply source 15 to the combustion chamber C side.

The plurality of secondary combustion-supporting gas ejection holes 45 are provided so as to penetrate the front plate portion 36B. The plurality of secondary combustion-supporting gas ejection holes 45 are arranged at equal intervals on the circumference in planar view.

The center of the circle passing through the plurality of secondary combustion-supporting gas ejection holes 45 coincides with the central axis 13A of the burner 13. The plurality of secondary combustion-supporting gas ejection holes 45 are all arranged so as to be inclined so that the injection direction thereof is toward the central axis 13A of the burner 13.

The plurality of secondary combustion-supporting gas ejection holes 45 inject the secondary combustion-supporting gas transported to the secondary combustion-supporting gas supply path 43 toward the combustion chamber C.

The number, positional relationship (layout), and the like of the raw material ejection holes 34, the primary combustion-supporting gas ejection holes 39, and the secondary combustion-supporting gas ejection holes 45 can be appropriately selected.

The ejection angles of the raw material ejection hole 34, the primary combustion-supporting gas ejection hole 39, and the secondary combustion-supporting gas ejection hole 45 can also be appropriately selected.

In the form of the burner 13, the number and positional relationship (layout) of the raw material ejection holes 34, the primary combustion-supporting gas ejection holes 39, and the secondary combustion-supporting gas ejection holes 45 are not limited to those shown in FIG. 2 or 3.

As shown in FIG. 1, the combustion-supporting gas supply source 15 is connected to the burner 13 (specifically, the primary combustion-supporting gas supply path 37 and the secondary combustion-supporting gas supply path 43 shown in FIG. 3). The combustion-supporting gas supply source 15 supplies the primary combustion-supporting gas into the primary combustion-supporting gas supply path 37 and supplies the secondary combustion-supporting gas into the secondary combustion-supporting gas supply path 43.

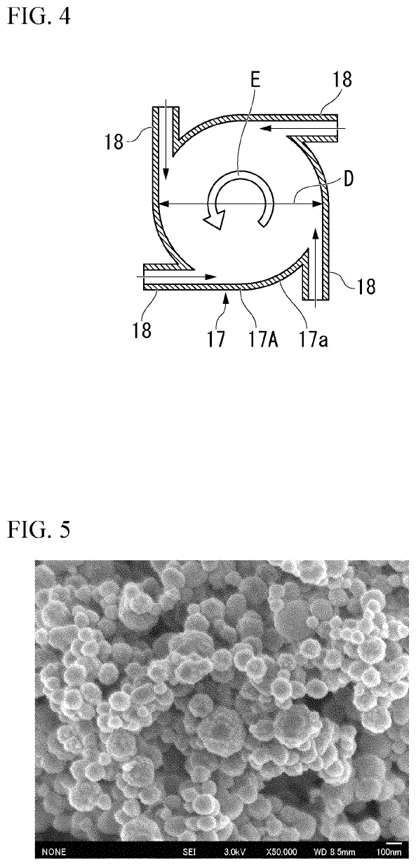

FIG. 4 is a diagram showing a cross section of the furnace and the inert gas supply unit shown in FIG. 1 taken along the line A-A. In FIG. 4, the same components as those shown in FIG. 1 are designated by the same reference numerals.

As shown in FIGS. 1 and 4, the furnace 17 has a cylindrical shape and extends in the vertical direction (Y direction). The cut surface (cross section taken along the line A-A) of the furnace 17 in the X direction (see FIG. 1) orthogonal to the vertical direction (Y direction) is a perfect circle. The inside of the furnace 17 is cut off from the outside air.

The burner 13 is mounted to the top (upper end) of the furnace 17 so that the tip end of the burner 13 faces downward.

A water-cooled structure (for example, a water-cooled jacket) (not shown) is provided on the side wall 17A of the furnace 17.

The inner diameter D in the furnace 17 may be, for example, 0.8 m.

The outlet 17B for extracting gas (specifically, a mixed gas of combustion exhaust gas and an inert gas, and the like) and the fine particles from the furnace 17 is provided below the region at which the plurality of inert gas supply units 18 are arranged in the lower portion 17-2 of the furnace 17. The outlet 17B is connected to the bag filter 21 via a transportation path 23.

As shown in FIGS. 1 and 4, the plurality of inert gas supply units 18 (for example, ports) are provided on the side wall 17A of the furnace 17 and protrude from the outer surface 17a of the side wall 17A of the furnace 17. The plurality of inert gas supply units 18 are arranged in the circumferential direction of the side wall 17A of the furnace 17 and in the extending direction (vertical direction) of the furnace 17.

The plurality of inert gas supply units 18 are connected to the inert gas supply source 19. The inert gas (for example, nitrogen) supplied from the inert gas supply source 19 is ejected into the furnace 17 through the plurality of inert gas supply units 18.

As shown in FIG. 4, the plurality of inert gas supply units 18 are arranged so that the extending direction thereof is the same as the tangential direction of the side wall 17A of the furnace 17. As a result, the uniform swirling flow E can be formed in the furnace 17 by the inert gas ejected into the furnace 17.

In the present embodiment, the generation of connected particles can be reduced by the swirling flow E. As a result, good spherical fine particles can be generated, and the dispersibility of the copper fine particles produced is further improved.

In the present embodiment, the furnace 17 having a water-cooled structure has been described as an example, but instead of this example, a furnace in which the side wall 17A is made of a refractory material (for example, brick, amorphous castable, etc.) may be used.

In the present embodiment, as shown in FIG. 1, an embodiment in which the three-stage inert gas supply unit 18 is arranged in the extending direction of the furnace 17 has been described as an example. However, the number of stages of the inert gas supply unit 18 in the extending direction of the furnace 17 is not limited to the number of stages shown in FIG. 1.

In the present embodiment, as shown in FIG. 4, an embodiment in which the four inert gas supply units 18 are provided in the circumferential direction of the side wall 17A of the furnace 17 has been described as an example. However, the number of the inert gas supply units 18 arranged in the circumferential direction of the side wall 17A of the furnace 17 can be appropriately selected as needed, and is not limited to the number of the inert gas supply units shown in FIG. 4.

In the present embodiment, as shown in FIG. 4, an embodiment in which are used as the plurality of inert gas supply units 18 has been described as an example, but slits may be used as the plurality of inert gas supply units 18.

The cooling gas supply source 20 supplies the cooling gas into the transportation path via the cooling gas path. Examples of the cooling gas include air, nitrogen gas, and argon, but the cooling gas is not particularly limited as long as it is an inert gas. The cooling gas can cool the fine particles and the gas transported from the outlet 17B of the furnace 17 to the bag filter 21.

The bag filter 21 includes a gas discharge unit 21A connected to the blower 22 and a fine particle collecting unit 21B. The gas discharge unit 21A is provided at the upper portion of the bag filter 21. The fine particle collecting unit 21B is provided at the lower end of the bag filter 21.

The bag filter 21 is connected to the outlet 17B of the furnace 17. Gas and the fine particles are transported into the bag filter 21 via the outlet 17B.

The fine particle collecting unit 21B of the bag filter 21 collects the fine particles among the gas and the fine particles transported from the furnace 17.

The blower 22 sucks the gas in the bag filter 21 via the gas discharge unit 21A and discharges the gas as an exhaust gas.

(Second Processing Unit)

The second processing unit 2 brings the fine particles transported from the first processing unit 1 into contact with pure water to dissolve the copper carbonate in the coating film.

The mixer 40 is not particularly limited as long as it can bring the fine particles into contact with pure water. Examples of the mixer 40 include an ultrasonic stirrer, a self-revolving mixer, a mill stirrer, and a stirrer using a stirring bar.

The mode of transporting the fine particles from the fine particle collecting unit 21B to the mixer 40 is not particularly limited.

The solid-liquid separator 41 is not particularly limited as long as it can separate fine particles after mixing pure water and water after dissolving copper carbonate. For example, a suction filter, a filter press, a centrifugal separator and the like can be exemplified.

(Effects)

The apparatus for producing the copper fine particles of the present embodiment described above includes the first processing unit in which fine particles having a coating film containing copper carbonate and cuprous oxide on at least a part of the surface are produced, and the second processing unit in which copper carbonate in the coating film is dissolved by bringing the fine particles into contact with pure water. Therefore, irregularities can be formed on the surface of the copper fine particles by dissolving the copper carbonate. As a result, the specific surface area of the copper fine particles is increased, and the reaction activity of the copper fine particles is increased, so that the copper fine particles can be sintered even in a low temperature range.

<Method for Producing Copper Fine Particles>

In the method for producing copper fine particles of the present embodiment, copper or a copper compound is heated in a reducing flame formed in a furnace by a burner, and the coating film containing copper carbonate and cuprous oxide is produced on at least a part of the surface thereof.

Next, in the method for producing copper fine particles of the present embodiment, the fine particles and pure water are brought into contact with each other to dissolve the copper carbonate in the coating film.

In the method for producing copper fine particles of the present embodiment, the carbon concentration of the fine particles may be controlled by adjusting the amount of carbon in the fuel gas supplied into the burner, or heat treating the fine particles in a carbon dioxide atmosphere before the fine particles are brought into contact with pure water.

Next, a method for producing copper fine particles of the present embodiment will be described with reference to FIG. 1.

First, a high-temperature reducing flame is formed at the upper portion 17 in the furnace 17-1 with the combustion-supporting gas and fuel gas by supplying a fuel gas, a raw material powder (powder containing copper or powder containing a copper compound), a primary combustion-supporting gas, and a secondary combustion-supporting gas in the burner 13. Thereby, the raw material powder is reduced by heating and evaporating the raw material powder in the high-temperature reducing flame.

Specifically, the upper portion 17-1 in the furnace 17 is used as a region for producing the fine particles. That is, copper or a copper compound as the raw material powder is heated, evaporated, and reduced at the upper portion 17-1 in the furnace 17. By heating, evaporating and reducing the raw material powder in the high-temperature reducing flame, fine particles having the coating film containing cuprous oxide on at least a part of the surface thereof are produced. The particle size of the fine particles is smaller than the particle size of the raw material powder and is usually submicron order or less.

In the present embodiment, it is preferable to control the carbon concentration of the fine particles by adjusting the amount of carbon in the fuel gas supplied to the burner 13.

By adjusting the amount of carbon in the fuel gas supplied to the burner and controlling the ratio of the mass carbon concentration (C/SSA) of the fine particles, adherence of an excessive amount of carbon to the surface of the fine particles can be suppressed. As a result, it is easy to produce fine particles which have the coating film containing copper carbonate, and are applicable to the production of the copper fine particles in which the sintering temperature is suppressed to a low level.

In the present description, the “amount of carbon” when adjusting the amount of carbon in the fuel gas supplied to the burner is the ratio of the carbon element concentration contained in the fuel. For example, when the fuel is methane+50% hydrogen, the fuel is a mixed gas of methane (CH₄): 1.175 m³/h and hydrogen (H₂): 3.9 m³/h, and the amount of carbon in the fuel can be calculated by

{(1.175×1)/(1.175×(1+4)+3.9×2)×100=8.6%}.

When heating copper or a copper compound in the reducing flame, a swirling flow may be formed at the lower portion 17-2 in the furnace 17 by ejecting an inert gas (for example, nitrogen) from the tangential direction of the side wall 17A of the furnace 17.

In the present embodiment, the particle size distribution of the fine particles may be adjusted by the swirling flow E, and the particle size distribution of the copper fine particles produced may be controlled within a desired range. By adjusting the particle size distribution of the fine particles, the dispersibility of the copper fine particles is further improved.

When adjusting the particle size distribution of the fine particles, for example, the strength of the swirling flow E may be adjusted. The strength of the swirling flow E can be adjusted by changing the amount of the inert gas ejected from the inert gas supply unit 18 (in other words, the amount of the inert gas ejected from the side wall 17A of the furnace 17 in the tangential direction of the furnace 17).

Specifically, the strength of the swirling flow E can be adjusted by controlling an S value that defines the strength of the swirling flow E (airflow swirling strength) in the furnace 17 represented by the following formula (2).

S=(Fs/Fz)/(D/d) (2)

In the formula (2), “Fs” is a momentum of the swirling gas (inert gas, and the like ejected from the inert gas supply unit 18) in the furnace 17, “Fz” is a momentum of the gas ejected from the burner 13 (carrier gas or the like that ejects the raw material from the raw material ejection hole 34 of the burner 13), “D” is an inner diameter of the furnace 17, and “d” is a diameter of the outlet in the burner 13.

In the formula (2), the S value that defines the strength of the swirling flow E is preferably more than 0.1. When the S value that defines the strength of the swirling flow E is more than 0.1, the number of connected particles contained in the fine particles generated in the furnace 17 can be reduced. Thereby, the copper fine particles produced can be suitably used in the field of electronic components at which the copper fine particles having a spherical shape are required.

For example, in the present embodiment, when a narrow (sharp) particle size distribution is required, an operation may be performed so that the S value becomes small. However, when S<0.1, a large number of connected particles tend to be generated. For example, in order to obtain a wide particle size distribution, an operation may be performed to increase the S value.

As the operation of reducing the S value, an operation of reducing the momentum of the swirling gas in the furnace 17 (that is, reducing the amount of the inert gas ejected from the inert gas supply unit 18) and an operation of increasing the momentum of the gas (that is, increasing the amount of each gas ejected from the burner 13) can be exemplified.

As described above, in the present embodiment, the particle size distribution of the fine particles can be controlled by changing the strength of the swirling flow E (the swirling strength of the air flow) in the furnace 17.

That is, it is possible to produce fine particles with a controlled particle size distribution by heating, evaporating, and reducing the raw material powder at the upper portion 17-1 in the furnace 17, and then adjusting the strength of the swirling flow E produced at the lower portion in the same furnace (the swirling strength of the air flow). As a result, the particle size distribution of the copper fine particles produced can be controlled within a desired range.

Therefore, since the particle size distribution of the fine particles can be controlled by continuous processing in the same furnace, compared with a method in which the step of producing fine particles and the step of classifying the produced fine particles are performed at different locations, the method of the present embodiment can easily generate the copper fine particles having a desired particle size distribution.

Further, since the particle size distribution of the fine particles can be controlled without carrying out a wet classification step, the copper fine particles that are difficult to aggregate and have excellent handleability can be produced by controlling the particle size distribution of the fine particles.

Next, the powder that has moved to the lower portion 17-2 of the furnace 17 passes through a flow field having a swirling flow E, and the fine particles are produced by the swirling flow E. After that, the fine particles are transported through the outlet 17B of the furnace 17 into the bag filter 21 while being cooled by the cooling gas supplied from the cooling gas supply source 20,

In general, the temperature of the gas discharged from the outlet 17B is 200˜700° C. In the present embodiment, a cooling gas may be mixed with the cooling gas so that the temperature of the gas after cooling becomes 100° C. or lower.

In the bag filter 21, the gas and the fine particles are separated, and the fine particles are acquired from the fine particle collecting unit 21B. This completes the production of the fine particles.

Next, in the method for producing copper fine particles of the present embodiment, the fine particles and pure water are brought into contact with each other to dissolve the copper carbonate in the coating film. Specifically, the fine particles are transported from the fine particle collecting unit 21B into the mixer 40.

By treating the fine particles with pure water in this way, the copper carbonate in the coating film on the surface of the fine particles is dissolved. As a result, irregularities are formed on the surface of the copper fine particles produced.

The method of bringing the fine particles into contact with pure water is not particularly limited. For example, ultrasonic stirring, a self-revolving mixer, mill stirring, a stirrer using a stirring bar, and the like can be used.

The pure water preferably does not contain components (for example, sodium, chlorine, etc.) that can inhibit sintering of the copper fine particles at 150° C. or lower. However, an impurity component may be contained as long as the effect of the present invention is not impaired.

The amount of the pure water used is preferably adjusted so that the concentration of fine particles in the mixed solution is 0.1˜500 g/L.

When the concentration of the fine particles is 500 g/L or less, the copper carbonate in the coating film on the surface of the fine particles is easily sufficiently dissolved, irregularities are easily formed, and Db/Dv is easily controlled within a predetermined range. When the concentration of the fine particles is 0.1 g/L or more, it is industrially advantageous in terms of cost in consideration of the treatment cost of the waste liquid and the like.

The fine particles are then transported from the mixer 40 into the solid-liquid separator 41. In the solid-liquid separator 41, water in which copper carbonate is dissolved and the copper fine particles are separated, and water is removed. Removal of water completes the production of the copper fine particles.

The method for removing water is not particularly limited. For example, the mixed solution may be solid-liquid separated and dried to obtain the copper fine particles. The method of separation is not particularly limited, but for example, suction filtration, a filter press, or the like may be used.

When drying, it is preferable to dry in an inert atmosphere such as nitrogen from the viewpoint of suppressing the oxidation of the copper fine particles.

In the present embodiment, it is preferable to heat-treat the fine particles in a carbon dioxide atmosphere before bringing the fine particles into contact with pure water. Before contacting the fine particles with pure water, the fine particles are heat-treated in a carbon dioxide atmosphere to control the ratio of the mass carbon concentration (C/SSA) of the fine particles and suppress an excess amount of carbon adhering to the surface of the fine particles. As a result, fine particles which can be used in the production of fine particles including the coating film containing copper carbonate, and in which the sintering temperature is suppressed to a low level can be easily produced.

In the heat treatment, for example, a batch type reactor equipped with a heater can be used as the heat treatment apparatus. The atmosphere inside the batch type reactor is controlled by inflowing gas into the reactor. The gas flowing into the reactor may contain an oxidizing gas containing a compound having a carbon element such as carbon dioxide, and may be a mixed gas of carbon dioxide and an inert gas (argon or the like).

The reactor may include a member that agitates the atmosphere in the reactor. Further, a continuous reactor provided with a transport member such as a conveyor may be used.

As a method of heat treatment, a flame of a burner may be used, or a heated gas may be flowed into the reactor. When the burner is used as the heating device, an indirect heating method is preferable from the viewpoint of controlling the atmosphere of the reactor.

The temperature in the heat treatment may be, for example, 40˜200° C. The time of the heat treatment depends on the heat treatment temperature, but may be, for example, 10 minutes˜100 hours. This is because when the treatment time is 10 minutes or more, a sufficient heat treatment effect can be obtained, and when it is 100 hours or less, the reaction is unlikely to proceed excessively.

In another embodiment, when it is used instead of the mixer 40, the pure water after contact is likely to evaporate. In this case, the removal of water by the solid-liquid separator 41 can be omitted.

(Effects)

In the method for producing copper fine particles of the present embodiment described above, the fine particles having a coating film containing copper carbonate and cuprous oxide on at least a part of the surface thereof are generated, and the fine particles and pure water are brought into contact with each other to dissolve the copper carbonate in the coating film. Thereby, irregularities can be formed on the surface of the copper fine particles by dissolving the copper carbonate. As a result, the specific surface area of the copper fine particles is increased, and the reaction activity of the copper fine particles is increased, so that the copper fine particles can be sintered even in a low temperature range. Further, since the particle size of the copper fine particles can be arbitrarily adjusted by controlling the particle size of the fine particles by the swirling flow E, it becomes easy to obtain the copper fine particles having sufficient dispersibility when made into a paste.

Although some embodiments of the present invention have been described above, the present invention is not limited to such specific embodiments. Furthermore, additions, omissions, replacements, or other modifications may be made within the scope of the gist of the present invention described in the claims.

### EXAMPLES

Hereinafter, the present invention will be specifically described with reference to Examples, but the present invention is not limited to the following description.

(Amount of Copper Carbonate and Cuprous Oxide Contained in Coating Film of Copper Fine Particles)

The amount of copper carbonate and cuprous oxide contained in the coating film of the copper fine particles was measured by XPS analysis using an XPS analyzer (“PHI Quantum 2000” manufactured by ULVAC-PHI).

(Sintering Temperature)

The specific resistance of the sintered body was measured by the 4-terminal method, and the temperature when the specific resistance became 100 μΩ·cm or less was defined as the sintering temperature.

### Examples 1 to 3

By changing the kind of fuel gas as shown in Table 1, the amount of carbon in the fuel gas was changed, and fine particles were produced using the apparatus 10 shown in FIG. 1. Specific conditions are shown below.

As the raw material powder, a powder of copper (II) oxide (average particle size: 10 μm), which is an example of the copper compound, was used.

Oxygen gas was used as the combustion-supporting gas.

As the combustion conditions, the low calorific value of the supplied fuel was 84108 (kJ/h), the oxygen ratio was 0.9, and the supply rate of the raw material powder was 0.36 (kg/h).

TABLE 1

| | | | Fine particle | | |
|---|---|---|---|---|---|
| | | | | XPS analysis | |
| | | | | Copper | |
| | Fuel gas | | Carbon | carbonate | Cuprous oxide |
| | | Amount of | (C) | (CuCO₃) | (Cu₂O) |
| | | Carbon | concentration | concentration | concentration |
| | Kind | [atomic %] | [% by mass] | [% by mass] | [% by mass] |
| Example 1 | Methane | 20 | 0.12 | 21.6 | 78.4 |
| Example 2 | Propane | 27 | 0.19 | 26.2 | 73.8 |
| Example 3 | Butane | 29 | 0.23 | 28.9 | 71.1 |
| Comparative Example 1 | Methane | 20 | 0.12 | 21.6 | 78.4 |

| | Copper fine particle | | | | | | | |
|---|---|---|---|---|---|---|---|---|
| | | XPS analysis | | | | | | |
| | | Copper | | | | | | |
| | | carbonate | Cuprous oxide | | | | | |
| | Carbon | (CuCO₃) | (Cu₂O) | | | | Sintering | Specific |
| | concentration | concentration | concentration | Dv | Db | Dv/Dv | temperature | resistance |
| | [% by mass] | [% by mass] | [% by mass] | [nm] | [nm] | [-] | [° C.] | [μΩ · cm] |
| Example 1 | 0.031 | 5.2 | 94.8 | 108 | 96 | 0.89 | 150 | 72 |
| Example 2 | 0.028 | 4.7 | 95.3 | 114 | 95 | 0.83 | 140 | 58 |
| Example 3 | 0.042 | 5.8 | 94.2 | 111 | 90 | 0.81 | 140 | 60 |
| Comparative Example 1 | — | — | — | 109 | 107 | 0.98 | 170 | 64 |

Copper (II) oxide powder was supplied to the furnace 17 together with the combustion-supporting gas, and the copper (II) oxide powder was heated in the reducing flame formed by the burner 13 to be evaporated and reduced. Fine particles of submicron order or less were produced inside the furnace 17.

Next, the fine particles produced and pure water were mixed and brought into contact with each other. Here, pure water was added so that the fine particle concentration was 50 g/L, and the mixture was mixed using an ultrasonic bath.

The mixed solution containing the fine particles and pure water was solid-liquid separated by suction filtration, copper fine particles produced were dried at room temperature in a nitrogen atmosphere to remove water, and the copper fine particles of Examples 1 to 3 were produced. Next, the Dv and Db of the copper fine particles produced were calculated as follows.

Measurement of Dv and Db in the Copper Fine Particles of Examples 1˜3

Dv: Dv was measured using a scanning electron microscope (SEM) (“JSM-6700F” manufactured by JEOL Ltd.). Specifically, pictures of the copper fine particles were taken in 3 fields of view at a magnification of 50,000 times, and the area equivalent diameter of the copper fine particles calculated using image processing software (“Scandium” manufactured by Olympus Soft Imaging Solution) for a total of 720 particles was defined as Dv.

Db: The specific surface area (SSA (m²/g)) of the copper fine particles was measured using a specific surface area meter (“Macsorb model-1201” manufactured by Mountech), and the particle size calculated by the following formula (1) was defined as Db.

Db=6/(SSA×ρ)×10⁹ (1)

In formula (1), copper density of 8.96 (g/m3) was used as ρ.

Then, 2-propanol was added to the copper fine particles of Examples 1 to 3 so that the concentration of the copper fine particles was 63% by mass, and the mixture was stirred to produce a paste conductive material of each example using a kneader (Awatori Rentarou) at 2000 rpm and 1 min. The paste conductive material was applied to a glass substrate and sintered at a constant temperature for 1 hour in a reducing atmosphere in which 3% by volume of hydrogen was added to nitrogen to produce a sintered body.

### Comparative Example 1

Fine particles produced under the same conditions as in Example 1 without contacting the fine particles with pure water were used as the copper fine particles of Comparative Example 1.

### Examples 4 to 7

In Examples 4 to 7, first, fine particles were produced under the same conditions as in Example 1.

Next, the fine particles were heat-treated in a carbon dioxide atmosphere. In Examples 4 to 7, heat treatment was performed in a carbon dioxide gas atmosphere at a treatment temperature of 80° C. for the treatment time shown in Table 2. Then, after contacting with pure water in the same manner as in Examples 1 to 3, water was removed to produce the copper fine particles of Examples 4 to 7.

Sintered products were produced in the same manner as in Examples 1 to 3 except that the copper fine particles of Examples 4 to 7 were used.

### Comparative Example 2

In Comparative Example 2, first, fine particles were produced under the same conditions as in Example 1.

Next, the fine particles were heat-treated in a carbon dioxide atmosphere. In Comparative Example 2, heat treatment was performed in a carbon dioxide gas atmosphere at a treatment temperature of 80° C. for 100 hours. Then, after contacting with pure water in the same manner as in Examples 1 to 3, water was removed to produce the copper fine particles of Comparative Example 2.

In Comparative Example 2, the copper fine particles to which 2-propanol was added did not become a paste, and it was difficult to produce a sintered body.

TABLE 2

| | | | Fine particle | | |
|---|---|---|---|---|---|
| | | | | XPS analysis | |
| | Fuel gas | | | Copper | |
| | | Time of | Carbon | carbonate | Cuprous oxide |
| | | heat- | (C) | (CuCO₃) | (Cu₂O) |
| | | treatment | concentration | concentration | concentration |
| | Kind | [h] | [% by mass] | [% by mass] | [% by mass] |
| Example 4 | Methane | 12 | 0.25 | 29.3 | 70.7 |
| Example 5 | Methane | 24 | 0.47 | 36.8 | 63.2 |
| Example 6 | Methane | 48 | 0.85 | 49.7 | 50.3 |
| Example 7 | Methane | 72 | 1.21 | 61.2 | 38.8 |
| Comparative Example 2 | Methane | 100 | 1.58 | 79.8 | 20.2 |

| | Copper fine particle | | | | | | | |
|---|---|---|---|---|---|---|---|---|
| | | XPS analysis | | | | | | |
| | | Copper | Cuprous | | | | | |
| | | carbonate | oxide | | | | | |
| | Carbon | (CuCO₃) | (Cu₂O) | | | | Sintering | Specific |
| | concentration | concentration | concentration | Dv | Db | Dv/Dv | temperature | resistance |
| | [% by mass] | [% by mass] | [% by mass] | [nm] | [nm] | [-] | [° C.] | [μΩ · cm] |
| Example 4 | 0.031 | 4.6 | 95.4 | 108 | 85 | 0.79 | 140 | 72 |
| Example 5 | 0.047 | 5.4 | 94.6 | 107 | 75 | 0.70 | 130 | 61 |
| Example 6 | 0.039 | 4.8 | 95.2 | 108 | 67 | 0.62 | 130 | 58 |
| Example 7 | 0.045 | 5.8 | 94.2 | 106 | 54 | 0.51 | 120 | 63 |
| Comparative Example | 0.048 | 5.7 | 94.3 | 105 | 47 | 0.45 | — | — |

FIG. 5 is a diagram showing an SEM photograph of the copper fine particles produced in Example 1. FIG. 6 is a diagram showing an SEM photograph of the copper fine particles produced in Comparative Example 1.

As shown in FIG. 5, irregularities were confirmed on the surface of the copper fine particles produced in Example 1. In addition, the spherical shape of the copper fine particles was maintained. Therefore, it is considered that copper fine particles which had sufficient dispersibility when made into a paste and could be sintered at a low temperature were obtained in Example 1.

As shown in FIG. 6, it was observed that the copper fine particles of Comparative Example 1 had a smooth surface. Further, although the dispersibility when made into a paste was good, the surface activity was insufficient in Comparative Example 1, and it is considered that sintering was difficult in a low-temperature range of 150° C. or less.

As shown in Tables 1 and 2, in Examples 1 to 7 in which the Db/Dv of the copper fine particles was within the range specified in the present invention, it was found that a paste conductive material was obtained, and sintering was possible in a temperature range (120 to 150° C.) lower than that of the conventional product.

From the results in Table 1, it was confirmed that the carbon concentration (carbonic acid concentration) of the copper fine particles could be controlled and Db/Dv could be controlled within a predetermined range by adjusting the carbon concentration in the fuel. It was found that the copper fine particles after the pure water treatment had good dispersibility and the sintering temperature could be controlled by adjusting the carbon concentration of the fine particles before the pure water treatment in the range of 0˜1.5%.

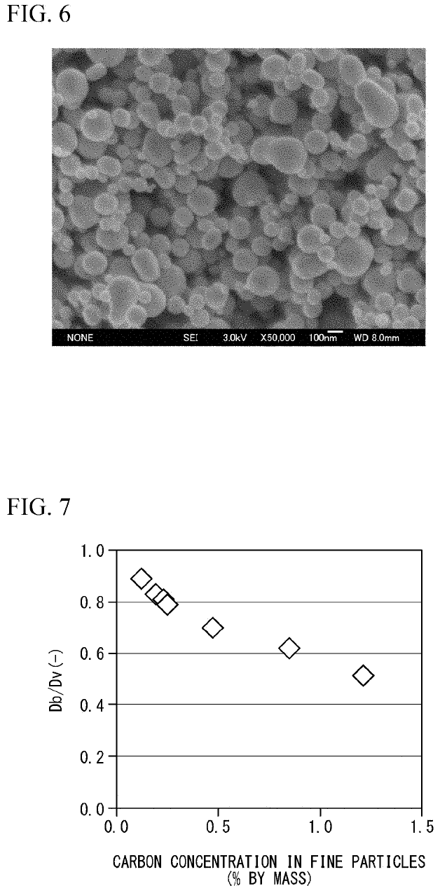

FIG. 7 is a diagram showing the relationship between the carbon concentration of the fine particles before the pure water treatment and the Db/Dv of the copper fine particles after the pure water treatment in Examples 1 to 7. It was found that the higher the carbon concentration of the fine particles before the pure water treatment, the smaller the Db/Dv of the copper fine particles after the pure water treatment.

On the other hand, when the carbon concentration of the fine particles before the pure water treatment exceeded 1.5%, the Db/Dv became 0.5 or less as in Comparative Example 2, the dispersibility was lowered, and it was difficult to make a paste.

In Comparative Example 2, it is considered that the reaction due to the heat treatment proceeded excessively. Therefore, it is considered that the dissolution of the copper carbonate on the surface of the fine particles by contact with pure water impaired the spherical shape of the copper fine particles produced and reduced the dispersibility.

### EXPLANATION OF REFERENCE NUMERALS

1 first processing unit
2 second processing unit
10 apparatus for producing copper fine particles
11 fuel gas supply source
12 raw material feeder
13 burner
13A central axis
15 combustion-supporting gas supply source
17 furnace
17a outer surface
17A side wall
17B outlet
17-1 upper portion
17-2 lower portion
18 inert gas supply unit
19 inert gas supply source
20 cooling gas supply source
21 bug filter
21A gas discharge unit
21B fine particle collecting unit
22 blower
23 transportation path
31 raw material supply pipe
31a tip end surface
32 raw material supply path
34 raw material ejection hole
36 primary combustion-supporting gas supply pipe
36A protrusion portion
36B front plate portion
37 primary combustion-supporting gas supply path
39 primary combustion-supporting gas ejection hole
40 mixer
41 solid-liquid separator
42 cooling jacket pipe
43 secondary combustion-supporting gas supply path
45 secondary combustion-supporting gas ejection hole
C combustion chamber
D inner diameter
E swirling flow

1. Copper fine particles,
wherein the copper fine particles have a coating film containing copper carbonate and cuprous oxide on at least a part of the surface thereof, and
a ratio between the following Db and the following Dv (Db/Dv) is in a range of 0.50˜0.90,
Dv: an average value (nm) of the area equivalent circle diameter of the copper fine particles obtained by acquiring SEM images for 500 or more copper fine particles using a scanning electron microscope, and calculating by image analysis software,
Db: a particle size (nm) of the copper fine particles obtained by measuring a specific surface area (SSA (m²/g)) of the copper fine particles using a specific surface area meter, and calculating by the following formula (1),
Db=6/(SSA×ρ)×10⁹ (1)
in the formula (1), ρ is a density of copper (g/m³).

2. The copper fine particles according to claim 1,
wherein the Dv is in a range of 50˜500 nm.

3. The copper fine particles according to claim 1,
wherein the Db is in a range of 25˜500 nm.

4. A conductive material,
wherein the conductive material contains the copper fine particles according to claim 1, and a dispersion medium in which the copper fine particles are dispersed.

5. An apparatus for producing the copper fine particles according to claim 1,
wherein the apparatus includes:
a first processing unit which includes a burner forming a reducing flame, and a furnace configured to store the burner, and which is configured to heat copper or a copper compound in the reducing flame, and produce fine particles having a coating film containing copper carbonate and cuprous oxide on at least a part of the surface thereof, and
a second processing unit which is configured to bring the fine particles into contact with pure water to dissolve the copper carbonate in the coating film.

6. A method for producing the copper fine particles according to claim 1, wherein the method includes:
heating copper or a copper compound in a reducing flame formed in a furnace by a burner to produce fine particles having a coating film containing copper carbonate and cuprous oxide on at least a part of the surface thereof; and
bringing the fine particles into contact with pure water to dissolve the copper carbonate in the coating film.

7. The method for producing the copper fine particles according to claim 6,
wherein an amount of carbon in the fine particles is controlled by adjusting an amount of carbon in a fuel gas supplied into the burner.

8. The method for producing the copper fine particles according to claim 6,
wherein the fine particles are heat-treated in a carbon dioxide atmosphere before the fine particles are brought into contact with pure water.
